(19) United States
(12) Patent Application Publication
(10) Pub. No.: US 2012/0168328 A1
(43) Pub. Date: Jul. 5, 2012

(54) K/D platform bed

(76) Inventor: Lionel T. Chen, Rowland Heights, CA (US)

(21) Appl. No.: 12/930,173

(22) Filed: Dec. 30, 2010

(51) Int. Cl. B65D 71/00; A47C 19/02; B25B 13/00; B23P 11/00

(52) U.S. Cl. 206/223; 29/428; 5/285; 81/52

(57) ABSTRACT

This invention provides a platform bed comprised of two oblong box portions that can be mated using three flat rectangles that bolt between the oblong box portions such that the platform surface remains flush along its length, as well as the two sides. There is also a head portion that bolts to one of the oblong box portions along the side furthest from the side at which the rectangles have mated to that oblong box portion. Feet and other items such as cushions, connective hardware and perhaps a simple wrench may be provided to complete the kit. The various parts of the kit can be nested together in their disassembled state such that they fit into a narrow flat box for easy storage and transport.

### CROSS REFERENCE TO RELATED APPLICATIONS

There are no related applications.

### STATEMENT REGARDING FEDERALLY SPONSORED RESEARCH AND DEVELOPMENT

This invention was not made using federally sponsored research and development. The inventor retains all rights.

### BACKGROUND OF THE INVENTION

This invention falls within the field of home furnishings generally, beds more specifically, and most specifically to kit beds that store readily for sale and transportation in relatively flat boxes. In the competitive home furnishings market consumers often shop in stores where the furniture is not pre-made and delivered, as it was under older commercial models. Now frequently the furniture piece is bought in a box, transported by the consumer and assembled by the consumer at home. There is a need within the industry for beds which can be readily fit within such a box and can be easily assembled by the consumer using only the simple wrench which is typically provided with the bed kit.

### BRIEF SUMMARY OF THE INVENTION

This invention concerns a platform bed that fulfills the above described need by providing a platform bed comprised of two oblong box portions that can be mated using three flat rectangles that bolt between the oblong box portions such that the platform surface remains flush along its length. There is also a head portion that bolts to one of the oblong box portions along the side furthest from the side at which the rectangles have mated to that oblong box portion. Feet and other items such as cushions, connective hardware and perhaps a simple wrench may be provided to complete the kit.

### BRIEF DESCRIPTION OF THE SEVERAL VIEWS OF THE DRAWINGS

FIG. 1 shows a collection of one each of the hardware parts of the kit.

FIG. 2 is an exploded diagram showing the non-hardware parts of the bed kit.

FIG. 3 shows the platform bed assembled but without cushions.

FIG. 4 shows an optional feature- drawers opening from the sides of the oblong box portions.

FIG. 5 shows an optional model sleeping two instead of one

FIG. 6 shows the parts of the invention disassembled and stored in a box.

FIG. 7 shows the first assembly step for the kit.

FIG. 8 shows the second assembly step for the kit.

FIG. 9 shows the first oblong box portion in semi-assembled condition.

FIG. 10 shows the second oblong box portion in semi-assembled condition.

FIG. 11 shows the third assembly step for the kit.

FIG. 12 is a close up of a headless bolt in correct position after the third assembly step.

FIG. 13 shows the fourth assembly step of the kit.

FIG. 14 shows the fifth assembly step of the kit.

FIG. 15 shows the sixth assembly step of the kit.

### DETAILED DESCRIPTION OF THE INVENTION

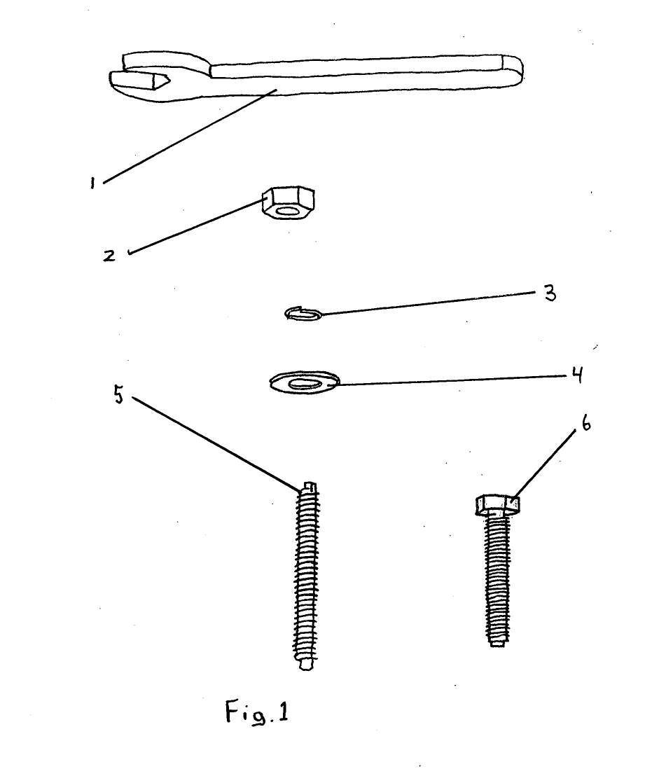

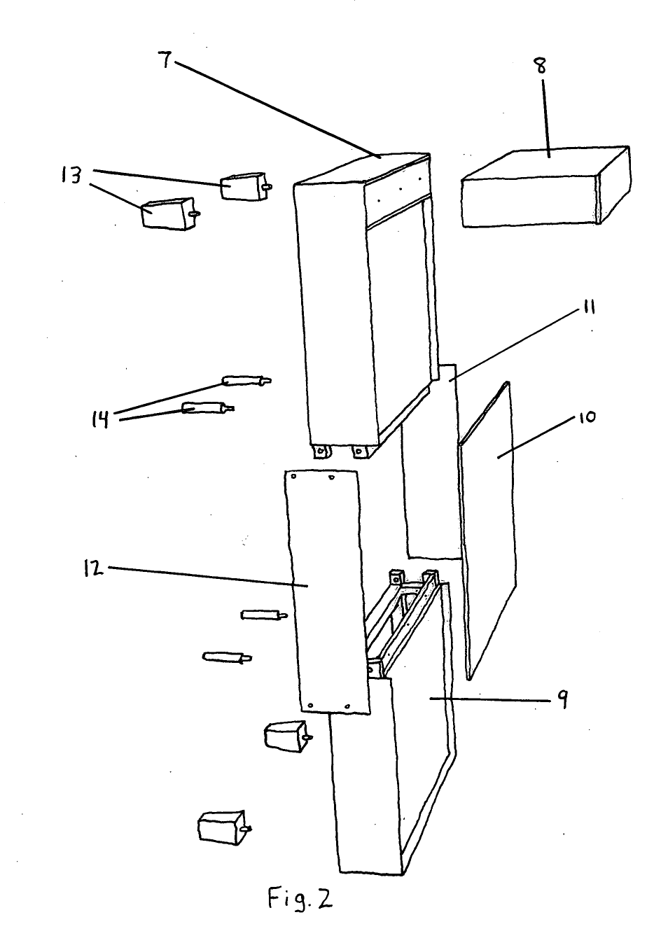

The K/D Platform Bed comes to the consumer in kit form. Included in the kit are a wrench (1), a plurality of hex nuts (2), a plurality of lock washers (3), a plurality of washers (4), a plurality of headless bolts (5), and a plurality of bolts (6) examples of which can all be seen in FIG. 1. Turning now to FIG. 2, the remaining parts of the kit proper (not including the box) can be seen. There is a first oblong box portion (7) which fundamentally is a box having rectangular sides. One of the sides has holes through which the headless bolts seen as (5) in FIG. 1 can fit. This side may also come equipped with a recess forming boundary rims that may hold cushions in place. A side perpendicular to the side having the bolt holes will have projections also adapted with holes, which in this case fit the bolts seen as (6) in FIG. 1. A head (8) is also included, and this head also has holes on one of its sides which fit the headless bolts (5). In general it is also basically a box with rectangular sides. The second oblong box portion (9) is similar to the first oblong box (7) except that the second oblong box (9) does not need the holes to fit the headless bolts (5) since it will form the foot of the bed and the head (8) will not attach to it. A platform rectangle (10) is included that is designed to mount flush with the platform region of the first oblong box portion (7) and the second oblong box portion (9) when it is used to connect the first oblong box portion (7) and the second oblong box portion (9). The platform rectangle (10) has holes which can fit the bolts (6). A first side rectangle (11) is included that is designed to mount flush with the first side region of the first oblong box portion (7) and the second oblong box portion (9) when it is used to connect the first oblong box portion (7) and the second oblong box portion (9). It has holes which can fit the bolts (6). A second side rectangle (12) is included that is designed to mount flush with the second side region of the first oblong box portion (7) and the second oblong box portion (9) when it is used to connect the first oblong box portion (7) and the second oblong box portion (9). It has holes which can fit the bolts (6). A plurality of feet (13) are included which can be attached to the bottoms of the first oblong box portion (7) and the second oblong box portion (9). Supports (14) are included which can also be attached to the bottoms of the first oblong box portion (7) and the second oblong box portion (9).

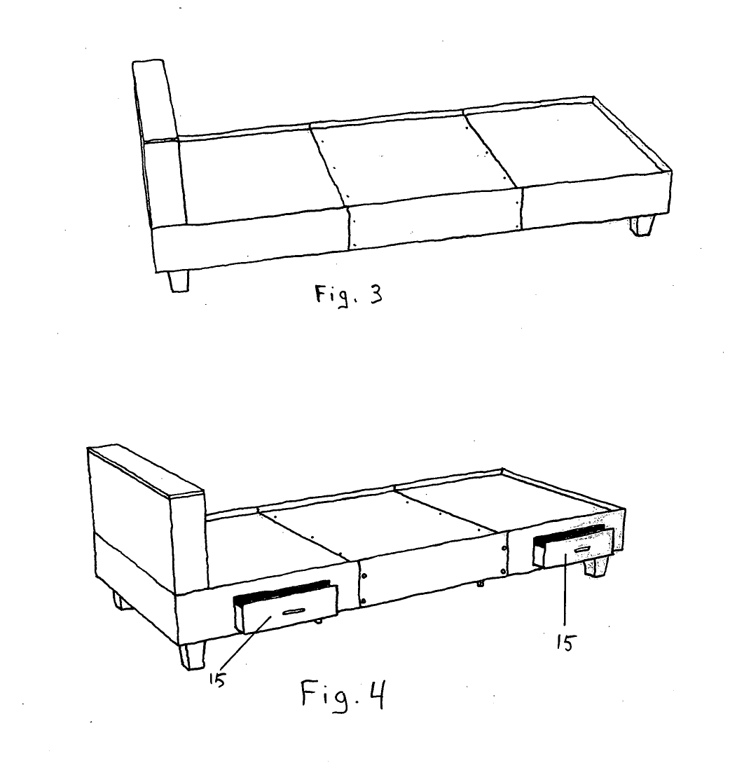

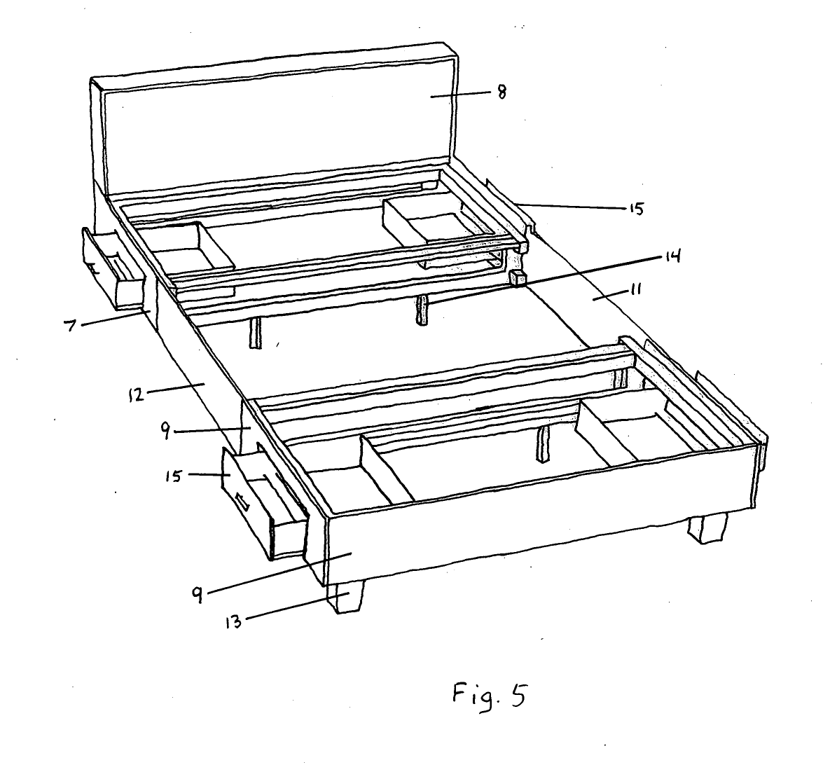

FIG. 3 shows how the K/D Platform Bed looks when it has been assembled. FIG. 4 shows the assembled bed with optional side drawers (15). FIG. 5 shows an alternative embodiment of the K/D Platform Bed which can sleep two and has two drawers (15) on each side. Turning now to FIG. 6, a box (16) can be seen into which the other parts of the kit can be fit in a nested fashion. The kit can be stored and transported easily because of its ability to be broken down in this manner.

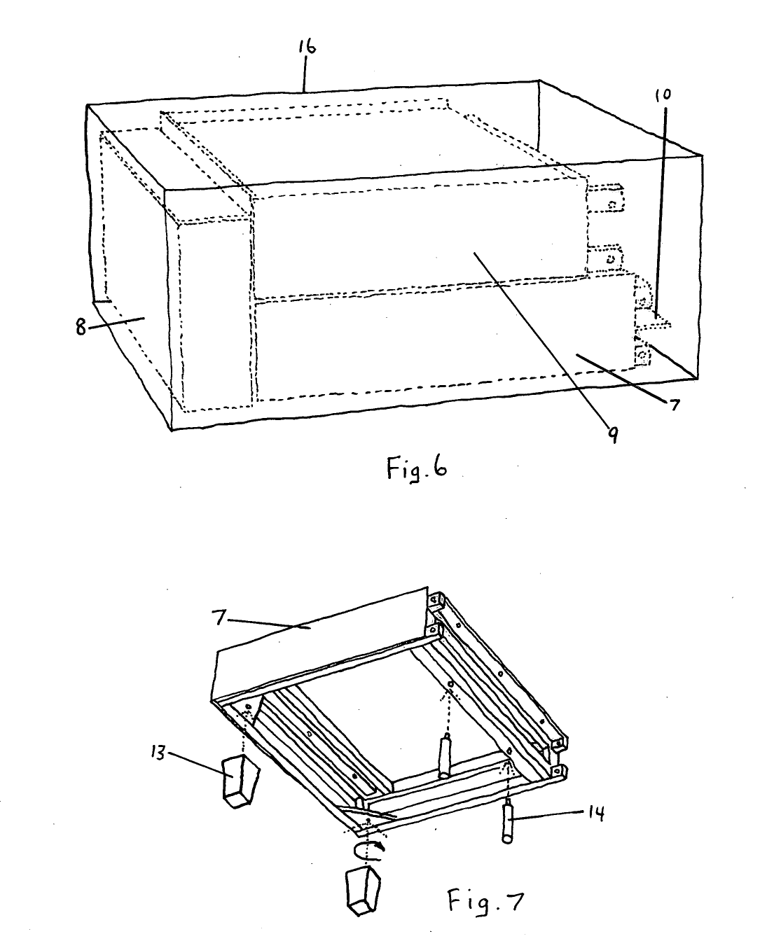

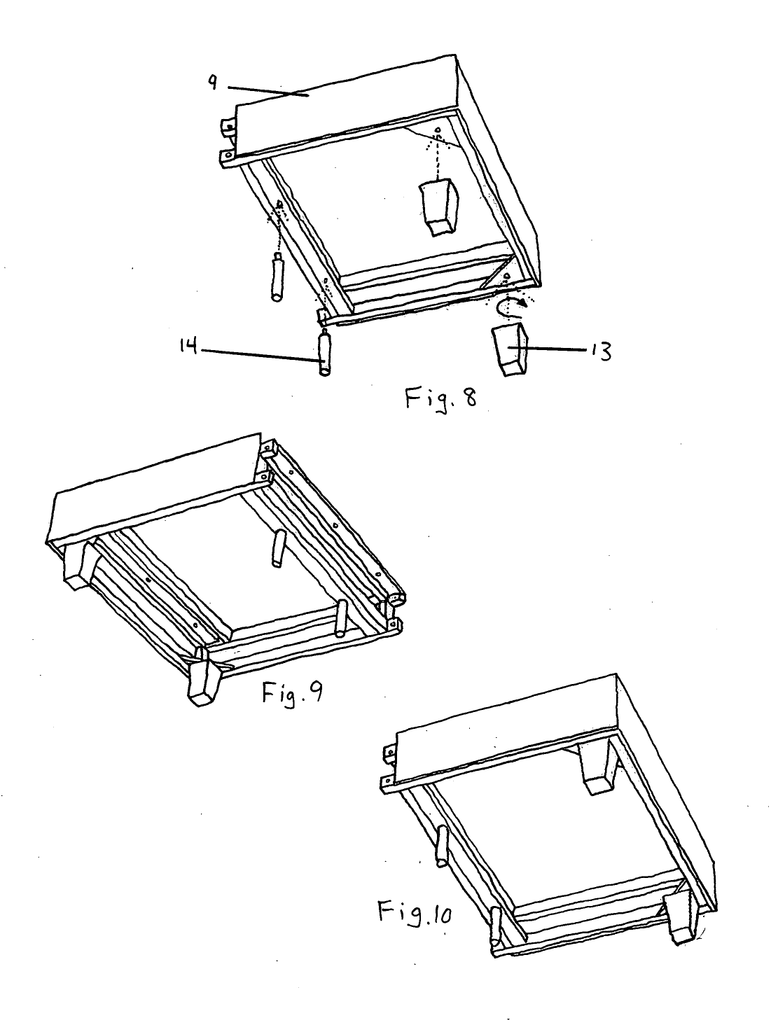

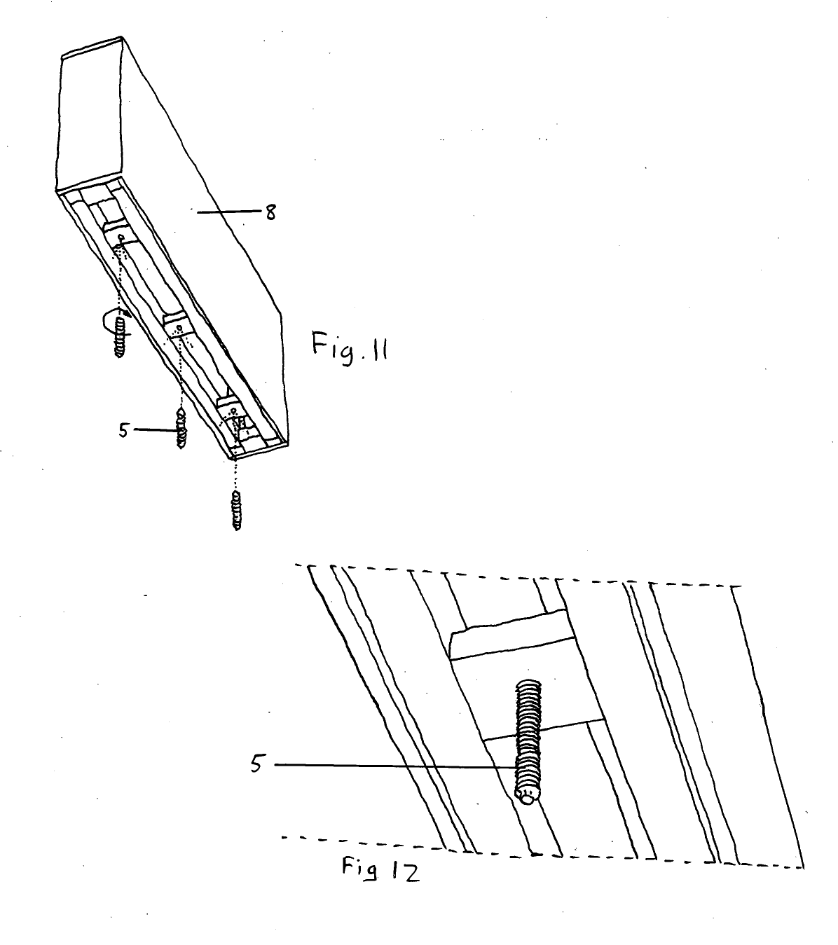

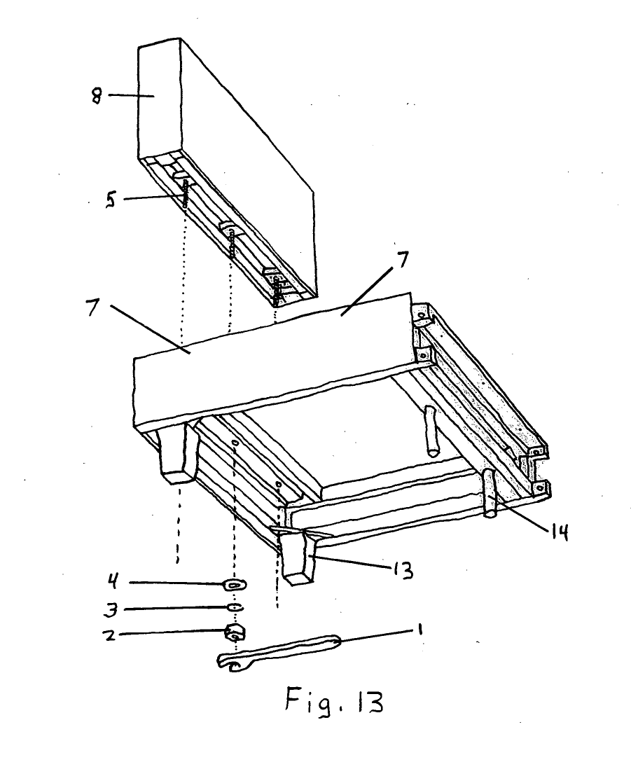

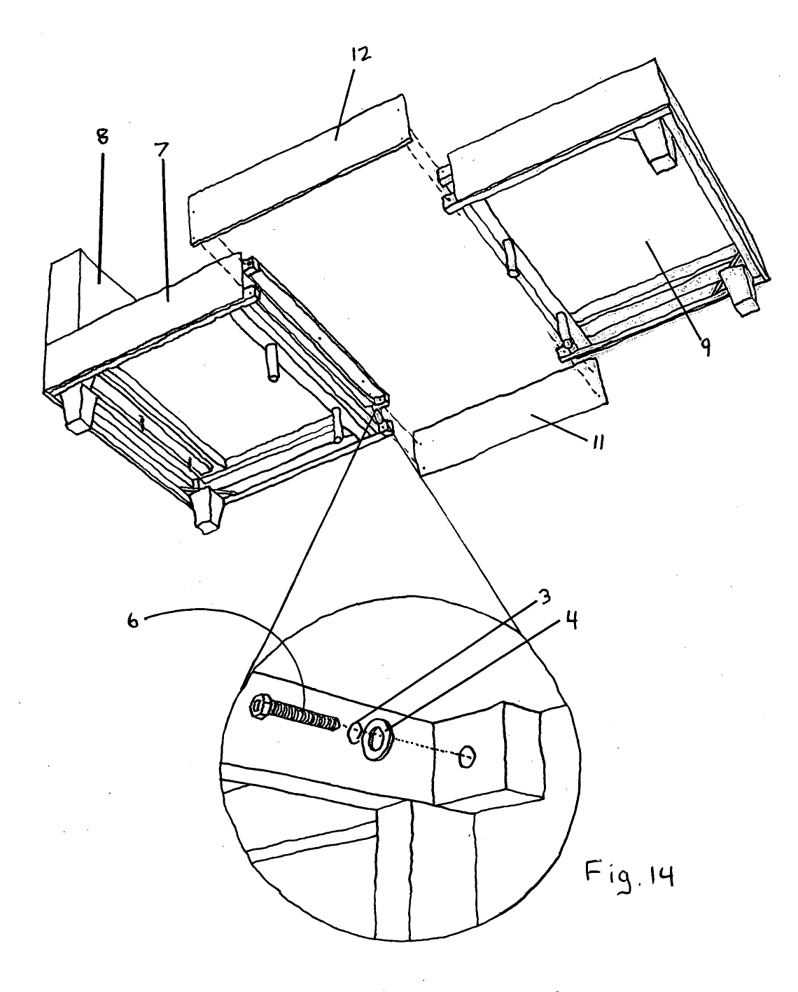

Turning now to FIG. 7, the first step in assembling the K/D Platform Bed can be seen. Feet (13) and supports (14) are screwed into holes found in the bottom of the first oblong box portion (7). Turning now to FIG. 8, the second step in assembling the K/D Platform Bed can be seen. Feet (13) and supports (14) are screwed into holes found in the bottom of the second oblong box portion (9). Turning now to FIG. 11, the third assembly step can be seen. Headless bolts (5) are screwed into holes on one side of the head (8). FIG. 12 shows a close-up view of how it looks when these headless bolts (5) are screwed into place. Turning to FIG. 13, the fourth assembly step can be seen to be fitting the headless bolts (5) of the head (8) through matching holes on the first oblong box portion (7). For each headless bolt (5), a washer (4) and then a lock washer (3) is placed onto the headless bolt (5) on the far side of the holes in the first oblong box portion (7). The wrench (1) is used to tighten a nut (2) onto each headless bolt (5). The fifth assembly step, seen at FIG. 14, involves using bolts (6) plus washers (4) and lock washers (3) to connect the first side rectangle (11) and second side rectangle (12) by their respective opposing ends to the first oblong box portion (7) and the second oblong box portion (9).

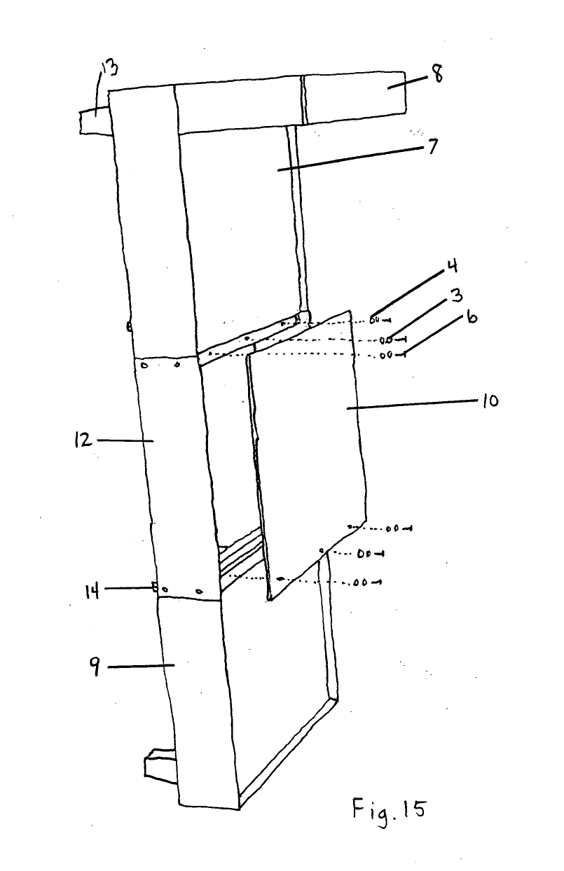

The sixth assembly step is shown at FIG. 15. The platform rectangle (10) is bolted into place to complete the connection of the first oblong box portion (7) and the second oblong box portion (9) so the platform bed has a flush platform surface along the full length of the top of the K/D Platform Bed. Again bolts (6), washers (4), and lock washers (3) are used although persons skilled in the art will realize that various alternative connection means can be employed to connect the parts of this invention. A mattress can be added to this platform to make a comfortable bed. In the preferred embodiment, the size of the upper bed surface will be made to match customary mattress sizes so commercial off the shelf mattresses can readily be used with the K/D Platform Bed.

I claim:

1. A platform bed kit comprising a first oblong box; a second oblong box; a head; a platform rectangle; a first side rectangle; a second side rectangle; and connection means.

2. The platform bed kit of claim 1 having a plurality of feet.

3. The platform bed kit of claim 1 having a wrench.

4. The platform bed kit of claim 1 having sliding drawers.

5. The platform bed kit of claim 4 further comprising a plurality of feet; said first oblong box attaching perpendicularly along a first edge to said head using said connection means; said platform rectangle attaching to said first oblong box along a second edge using said connection means; said first edge being parallel to said second edge; said platform rectangle attaching to said second oblong box distally from said second edge; said first side rectangle attaching to said first oblong box using said connection means so that said first side rectangle is perpendicular to said platform rectangle; said first side rectangle attaching to said second oblong box using said connection means; said first side rectangle attaching to said second oblong box at a point distal to said first oblong box; said second side rectangle attaching to said first oblong box using said connection means so that said second side rectangle is perpendicular to said platform rectangle; said second side rectangle attaching to said second oblong box using said connection means; said second side rectangle attaching to said second oblong box at a point distal to said first oblong box; said second side rectangle attaching to said first oblong box so that said second side rectangle is parallel to said first side rectangle; said feet attaching to said first oblong box on a surface opposite said head using said connection means; and said feet attaching to said second oblong box on a plane that is coplanar with said surface opposite said head using said connection means.

6. The platform bed kit of claim 5 having an external container.

7. The platform bed kit of claim 1 further comprising a plurality of feet; said first oblong box attaching perpendicularly along a first edge to said head using said connection means; said platform rectangle attaching to said first oblong box along a second edge using said connection means; said first edge being parallel to said second edge; said platform rectangle attaching to said second oblong box distally from said second edge; said first side rectangle attaching to said first oblong box using said connection means so that said first side rectangle is perpendicular to said platform rectangle; said first side rectangle attaching to said second oblong box using said connection means; said first side rectangle attaching to said second oblong box at a point distal to said first oblong box; said second side rectangle attaching to said first oblong box using said connection means so that said second side rectangle is perpendicular to said platform rectangle; said second side rectangle attaching to said second oblong box using said connection means; said second side rectangle attaching to said second oblong box at a point distal to said first oblong box; said second side rectangle attaching to said first oblong box so that said second side rectangle is parallel to said first side rectangle; said feet attaching to said first oblong box, on a surface opposite said head using said connection means; and said feet attaching to said second oblong box on a plane that is coplanar with said surface opposite said head using said connection means.

8. A method for assembling a platform bed comprising the steps of
a. providing a first oblong box;
b. providing a second oblong box;
c. providing a head;
d. providing a platform rectangle;
e. providing a first side rectangle;
f. providing a second side rectangle;
g. providing connection means;
h. attaching said first oblong box perpendicularly along a first edge to said head using said connection means;
i. attaching said platform rectangle to said first oblong box along a second edge parallel and distal to said first edge using said connection means;
j. attaching said first side rectangle to said first oblong box using said connection means so that said first side rectangle is perpendicular to said platform rectangle;
k. attaching said first side rectangle to said second oblong box at a point distal to said first oblong box using said connection means;
l. attaching said second side rectangle to said first oblong box using said connection means so that said second side rectangle is perpendicular to said platform rectangle;
m. attaching said second side rectangle to said second oblong box at a point distal to said first oblong box using said connection means so that said second side rectangle is parallel to said first side rectangle;
n. attaching said feet to said first oblong box on a surface opposite said head using said connection means; and
o. attaching said feet to said second oblong box on a plane that is coplanar with said surface opposite said head using said connection means.
